(19) United States
(12) Patent Application Publication
(10) Pub. No.: US 2009/0047410 A1
(43) Pub. Date: Feb. 19, 2009

(54) RTH Risotto

(75) Inventor: Yah-Hwa E. Lin, Cerritos, CA (US)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 11/838,635

(22) Filed: Aug. 14, 2007

(51) Int. Cl. A23L 1/182; A23L 1/01

(52) U.S. Cl. 426/618; 426/392

(57) ABSTRACT

A process for the production of a shelf-stable ready-to heat risotto food product that includes the steps of: providing a blend of parboiled and non-parboiled rice grains, filling a plurality of retortable containers with the blend of rice grains and adding the ingredients of oil, water and seasonings to each container. Each container is then sealed and sterilized. After heating by a consumer, the risotto food product has a texture comparable to traditionally prepared risotto. Also provided is shelf stable, ready-to-eat risotto food product having a blend of parboiled and non-parboiled rice grains; wherein the blend of parboiled and non-parboiled rice grains provide a surface creaminess and al dente texture of traditionally prepared risotto.

### TECHNICAL FIELD

The present invention is directed to a rice food product and more specifically to a shelf stable ready-to-heat risotto food product.

### BACKGROUND OF THE INVENTION

Risotto is a method of cooking rice that has its origins in Italy. The objective when making risotto is to achieve a creamy texture in which the rice grains retain their al dente core. Typically arborio or carnaroli rice varieties are used. The creaminess is not brought about by the addition of cream or any dairy product, but rather is the gelatinization of the starch molecules through gentle heating and stirring and the addition of liquid. Almost by definition, risottos defy simplified commercial preparation. This is because risotto is less a dish in itself than a hands-on-cooking technique that tests a cook's capacity for practice and perseverance, particularly when it comes to stirring.

In risotto, a shorter-grain rice with branched amlyopectin starch is used. The rice is not rinsed because the dish needs the surface starch for creaminess. Gelatinization of the light coating of surface starch is as essential to a creamy risotto as the swelling of the starch inside the grain. The cooking liquid is added gradually to gelatinize the starch little by little and constant stirring is required to incorporate incremental additions of liquid. It typically takes as long as 60 to 90 minutes to prepare a risotto and the finished texture is creamy, sticky and porridge-like.

Few specially processed instant risotto rices are available to speed preparation. A number of unprocessed low-amylose rice varieties can substitute for arborio or carnaroli rice, however, replacements for these rice varieties do not quite yield the firm kernel center of a true risotto rice. Available fully-cooked shelf stable products are typically made with parboiled arborio rice. Quick-cooking instant risotto takes about 10 minutes to cook. Other commercially available risotto products do not fall into the convenient category as they take significantly longer to cook.

The creaminess, if not the al dente core, of a traditional risotto rice can be simulated by including rice flour in a boxed risotto mix. The creaminess can also be simulated through the addition of dairy ingredients. Blends of other grains, such as barley and spelt, are used with parboiled rice in order to attempt to achieve the creaminess. A common food service practice is to prepare the risotto ahead of time and refrigerate or freeze it for later use. However, this process negatively impacts the quality of the cooked risotto and does not completely solve the convenience issue, since the risotto still requires the lengthy preparation time.

It would be desirable to have a shelf-stable, ready-to-heat risotto that has the surface creaminess and the al dente texture of a traditional risotto without the long cooking times.

It would also be desirable to have a shelf-stable, ready-to-heat risotto that does not rely on or require the inclusion of additional oil, fats, emulsifiers or texturizers in order to achieve the desired textural properties.

### BRIEF SUMMARY OF THE INVENTION

The present invention is directed to a process for the production of a shelf-stable ready-to heat risotto food product. The method includes the steps of providing a blend of parboiled and non-parboiled rice grains, filling a plurality of retortable containers with the blend of rice grains and adding the ingredients of oil and water, and optionally seasonings, to each container. Each container is thereafter sealed and sterilized. After heating by a consumer, the risotto food product has a texture comparable to traditionally prepared risotto.

The blend of rice grains includes 15-45% of the non-parboiled rice and 55-85% of the parboiled rice. Preferably, the blend of rice grains includes 20-35% of the non-parboiled rice and 65-80% of the parboiled rice. More preferably, the blend of rice grains includes 25-30% of the non-parboiled rice and 70-75% of the parboiled rice.

The blend of rice grains for a foodservice product includes 1-40% of the non-parboiled rice and 60-99% of the parboiled rice. Preferably, the blend of rice grains for the foodservice product includes 5-35% of the non-parboiled rice and 65-95% of the parboiled rice. Most preferably, the blend of rice grains for the foodservice product includes 15-30% of the non-parboiled rice and 70-85% of the parboiled rice.

The texture of the risotto food product comprises the surface creaminess and al dente bite of traditionally prepared risotto.

The method further includes the steps of adding additional liquid and heating prior to consumption by a consumer.

The subject invention is also directed to a shelf stable risotto food product that includes ready-to-heat risotto having a blend of parboiled and non-parboiled rice grains in which the blend of parboiled and non-parboiled rice grains provide a surface creaminess and al dente texture of traditionally prepared risotto.

The blend of rice grains includes 15-45% of the blend is non-parboiled rice and 55-85% of the blend is parboiled rice. Preferably, the blend of rice grains includes 20-35% of the non-parboiled rice and 65-80% of the parboiled rice. More preferably, the blend of rice grains includes 25-30% of the non-parboiled rice and 70-75% of the parboiled rice.

The parboiled rice is a milled rice, has as a low to intermediate amylose content, and is selected from the group consisting of short grain rice and medium grain rice.

The non-parboiled rice is a milled rice, has a low to intermediate amylose content, and is selected from the group consisting of short grain rice and medium grain rice.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a graph of a comparison of the sensory attributes of reference samples and a sample of the inventive rice blend;

FIG. 2 is a graph of a comparison of the texture qualities of different blends of rice varieties at a 0 hour hold; and

FIG. 3 is a graph of a comparison of the texture qualities of different blends of rice varieties after 3 hours in a steam table.

### DETAILED DESCRIPTION OF THE INVENTION

As used herein, the use of the word “a” or “an” when used in conjunction with the term “comprising” in the claims and/or the specification may mean “one,” but it is also consistent with the meaning of “one or more”, “at least one,” and “one or more than one.”

Degree of stickiness is defined as the overall impression of the extent of stickiness of rice grains ranging from separate to sticky.

Adhesiveness is defined as the force required to remove the sample that adheres to a specific surface like lips, palate or teeth ranging from separate to sticky.

Chewiness is defined as the number of chews needed to masticate the sample to a consistency suitable for swallowing ranging from low to high.

Denseness is defined as the compactness of cross section of sample after biting completely through with molars ranging from light to heavy.

Mouthfeel is defined as the degree of sensation in the mouth after the first bite or chew of sample ranging from smooth to coarse.

Grittiness is defined as the degree to which sample contains small gritty particles ranging from Low to High.

Creaminess is defined as a texture that is very smooth and free from gritty, lumpy, grainy or abrasive particles.

Ready to Eat products (also known as Ready to Heat) are defined as those known to have achieved shelf stability by means of an approved thermal process and are safe and ready to be consumed upon opening its packaging and/or heating. The Code of Federal Regulations (9 CFR 430) defines a Ready-to-eat (RTE) product as a meat or poultry product that is in a form that is edible without additional preparation to achieve food safety and may receive additional preparation for palatability or aesthetic, epicurean, gastronomic, or culinary purposes. An RTE product is not required to bear a safe-handling instruction (as required for non-RTE products by 9 CFR 317.2(1) and 381.125(b)) or other labeling that directs that the product must be cooked or otherwise treated for safety, and can include frozen meat and poultry products. In the embodiments of this application, RTH means ready for consumption after 30-180 seconds of microwave heating.

Shelf-stable foods are defined by the Code of Federal Regulations (9 CFR 381.300 (u)) as follows: Shelf stability is the condition achieved by application of heat, sufficient, alone or in combination with other ingredients and/or treatments, to render the product free of microorganisms capable of growing in the product at non-refrigerated conditions (over 50° F. or 10° C.) at which the product is intended to be held during distribution and storage. Shelf stability and shelf stable are synonymous with commercial sterility and commercially sterile, respectively.

When a rice grain is harvested it consists of an inner, starchy kernel, a layer of bran firmly adhered to the kernel, and a husk (also known as the hull) loosely surrounding and enclosing the kernel and the bran. The husk can be removed quite easily to leave the kernel and bran layer.

The term “milling” is used in this specification to describe removal of the bran from brown rice by abrasive milling machinery. Suitably, from about 5% to about 15% of the weight of the brown rice is removed in the milling step, for example from about 8% to about 12%. The product following milling is termed “white rice” or “milled rice” and consists of starchy rice kernels ready for cooking.

Parboiling is the name given to a process that comprises soaking and steaming the rice while the bran (and optionally also the husk) is still attached to the grains. The soaking and steaming causes nutrients from the bran and the husk to diffuse into the starchy kernel. Moreover, the soaking and steaming causes the starch in the kernels to gelatinise. That is to say, the starch in the kernels (which is partially crystalline before parboiling) reacts with water at elevated temperatures to form an amorphous gel. The soaked and steamed grains are then dried back to 12-14% moisture content for milling. The starch in the rice kernels remains in an amorphous state after drying, but the drying causes the starch to revert from a gel to a glassy state. The gelatinisation of the starch also has the effect of strengthening the rice kernels, so that breakage losses during milling are substantially reduced. The parboiled and dried grains may then be milled to remove the husk and the bran layers to provide a milled rice kernel having the starch substantially in an amorphous (glassy) state. This milled parboiled rice has been the staple commercial rice product in the western world for the last 50 years.

Parboiled milled rice differs from non-parboiled milled rice in at least the following respects: gelatinized starch, yellow color (due to diffusion of color components from the bran during parboiling), higher nutrient levels due to diffusion of nutrients from the bran during parboiling), lower soluble starch content (due to losses during parboiling) and longer cooking times. The term “parboiled rice” herein therefore refers to any rice that has undergone the above treatment with water and heat to gelatinize the rice starch while the bran was attached to the kernels. The term “non-parboiled rice” refers to rice that has not undergone such treatment before milling to remove the bran.

The present invention is directed to a shelf-stable ready-to-heat (RTH) risotto food product. Achieving the desired eating characteristics of traditional risotto is typically done by using medium grain non-parboiled rice and a slow stove-top cooking process. The characteristics of surface creaminess and al dente bite in traditional risotto are desired by the consumer in both foodservice and retail products. Optimum eating quality is mostly present in a freshly prepared risotto food product. The traditional stove-top process is slow, taking as long as 60-90 minutes to prepare, and is very inconvenient for the consumer and not practical for foodservice operators.

A convenient, shelf-stable, high quality risotto product can be obtained by utilizing a combination of non-parboiled and parboiled medium grain rice. The inventive risotto food product delivers comparable eating characteristics (surface creaminess and al dente texture) of a traditional stove-top risotto (made with non-parboiled rice) or a shelf-stable product made with a parboiled medium grain rice such as Uncle Ben's® Classic Risotto. The texture of the risotto food product typically has an intermediate texture firmness—it is not too hard, nor too firm.

Combining parboiled and non-parboiled rice in the same product is contrary to both a commercial and consumer's practice of rice preparation because the cooking performance of these two types of rice is very different. With parboiled rice, hydration is different than that of non-parboiled rice because non-parboiled rice losses more solids during cooking than parboiled rice. Additionally, the ability to withstand thermal processing is also very different between these two types of rice. Parboiled rice typically holds its integrity and maintains better shape upon retorting compared to non-parboiled rice. Therefore, using a combination of parboiled and non-parboiled rice is not thought of as an appropriate option for any rice product and especially for use in the preparation of risotto either from scratch or as a cooked, shelf-stable, ready to heat product. Further, the inventive risotto food product does not rely upon or require the addition of additional oil, fats, emulsifiers or texturizers in order to achieve the desired textural properties.

In the inventive risotto food product, it has been very surprising to find that in the retort process, the non-parboiled medium-grain rice imparts a surface creaminess, adhesiveness and degree of stickiness to the food product and the parboiled medium-grain rice imparts consistent cooking performance during both the thermal processing and the stove-top heating.

The RTH risotto is closest in taste and texture to a traditional stove-top risotto when 15-45% of the non-parboiled rice and 55-85% of the parboiled rice are blended. A more preferred blend is 20-35% of the non-parboiled rice and 65-80% of the parboiled rice and a most preferred blend is 25-30% of the non-parboiled rice and 70-75% of the parboiled rice.

The parboiled rice is a rice variety selected from a group consisting of short and medium grain milled rice that are of low to intermediate apparent amylose content (8%-24% w/w of the total starch), preferably from 12%-22% w/w of the total starch. The parboiled milled rice has about 5%-15% w/w. (based on the total dry whole grain brown rice) of bran removed from the rice, and preferably from 8%-12% (based on the total dry whole grain brown rice) of bran removed from the rice. Typically the parboiled milled rice has off-white to yellowish beige color due to the color development from the parboiling (hydrothermal) process. The non-parboiled rice is a rice variety selected from a group consisting of short and medium grain milled rice that are of low to intermediate apparent amylose content (8%-24% w/w of the total starch), preferably from 12%-22% w/w of the total starch. The non-parboiled white rice has about 5%-15% w/w. (based on the total dry whole grain brown rice) of bran removed from the rice, and preferably from 8%-12% (based on the total dry whole grain brown rice) of bran removed from the rice. The non-parboiled rice is off-white to chalky white to translucent white color. The rice varieties can be from Europe, Asia, Africa, North America and South America. An example of varieties of medium grain rice are Loto, Arborio, Baldo and Carnaroli. An example of varieties of short grain rice are Koshihikari and Tamaki.

The range of grain size among typical European and USA medium and short grain rice is shown in the table below:

| | EC Regulations | | USA Regulations | | |
|---|---|---|---|---|---|
| | Length | Length/width | Length | Width | Weight/1000 |
| Type | (mm) | Ratio | (mm) | (m) | (g) |
| Medium | >5.2 | <3.0 | 5.9-6.1 | 2.5-2.8 | 18-22 |
| Short | <5.2 | <2.0 | 5.4-5.5 | 2.8-3.0 | 22-24 |

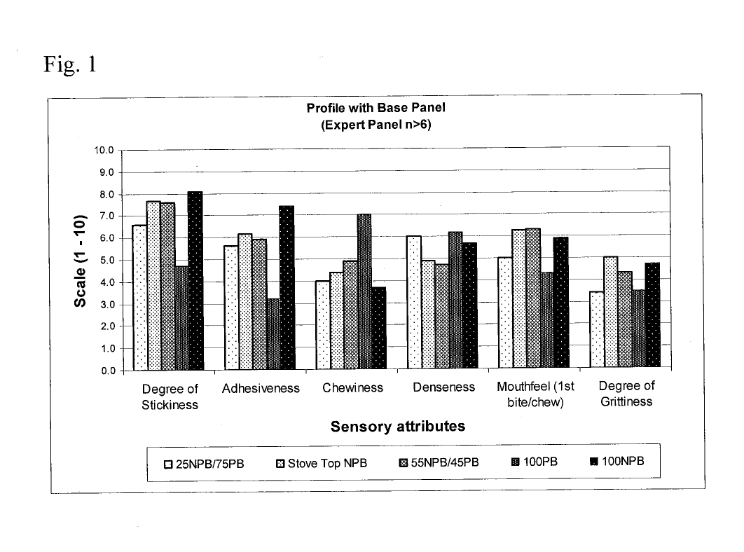

The results of a descriptive analysis comparison are shown in FIG. 1 that illustrates the sensory attributes of reference samples and samples of the inventive rice blend. The comparison was made between a blend of 25% non-parboiled rice/75% parboiled rice (25 NPB/75 PB), stove top non-parboiled rice (Stove Top NPB), of 55% non-parboiled rice/45% parboiled rice (55 NPB/45 PB), 100% parboiled rice (100 PB), and 100% non-parboiled rice (100 NPB). The sensory attributes compared were degree of stickiness, adhesiveness, chewiness, denseness, mouthfeel, and degree of grittiness.

As illustrated in FIG. 1, the stove top sample is closer to the blend versus 100% parboiled or 100% non-parboiled samples. The sample made with 25% of the non parboiled Arborio rice and 75% of the parboiled Loto rice (25 NPB/75 PB), has the closest profile to that of Uncle Ben's® fully-cooked shelf stable Classic Risotto made with 100% parboiled Arborio (100 PB). Decreasing the ratio of non parboiled to parboiled rice (55 NPB/45 PB) results in a closer profile to that of the stove-top risotto (Stove Top NPB) made with standard or other commercially available risotto samples such as the Adolphus® brand of rice. The 100% NPB came close to stovetop reference only on one attribute, grittiness. And it is a negative quality attribute against the desired creaminess.

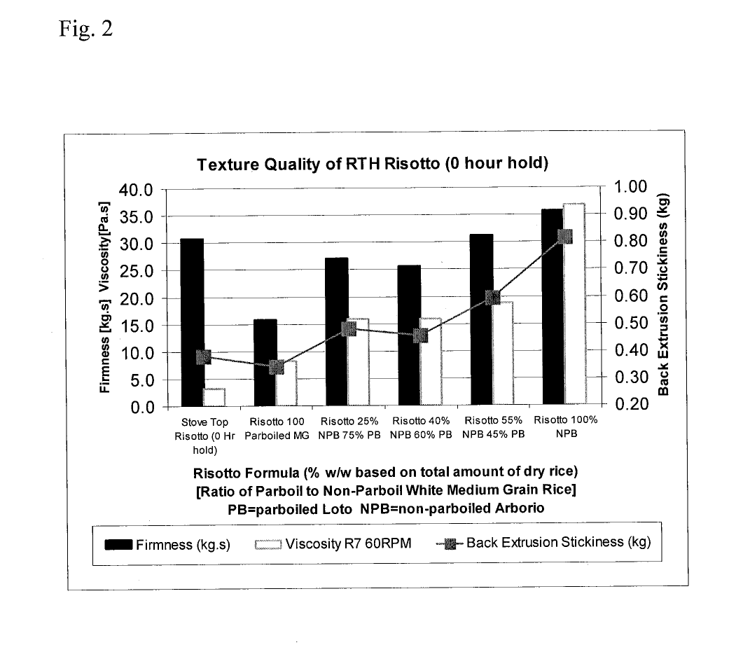

FIG. 2 is a graph that illustrates the texture quality of different risotto samples made with different ratios of parboiled and non-parboiled rice. As illustrated, using 100% parboiled rice results in very different textural properties than when using 100% non-parboiled rice: 1. there is more firmness with a higher ratio of non-parboiled medium grain rice in the formula; 2. there is a stronger negative back extrusion stickiness with an increase in the amount of non-parboiled medium grain white rice; and 3. the viscosity increases as the per cent of non-parboiled medium grain white rice is increased in the formula. Viscosity is a measurement of the resistance to flowability and low viscosity is an indicator of creaminess.

For use of the RTH risotto in the foodservice industry, the taste and texture is closest to a traditional stove-top risotto when 1-40% (weight basis of the total amount of dry rice) of the non-parboiled rice and 60-99% (weight basis of the total amount of dry rice) of the parboiled rice are blended. A more preferred blend is 5-35% of the non-parboiled rice and 65-95% of the parboiled rice and a most preferred blend is 15-30% of the non-parboiled rice and 70-85% of the parboiled rice.

For the foodservice consumer, the risotto food product has to have steam-table stability. This has typically been difficult with a rice product such as risotto, because as the risotto is held in a steam-table, the moisture equilibrates which changes the surface creaminess and al dente texture of the rice grains. The risotto of the subject invention has been found to remain steam-table stable for up to three hours at 165° F.

A steam table holding test was performed to evaluate the inventive food product performance in a simulated food service environment. The test was performed on the preferred risotto food product suitable for food service consumers. The material used in the test include a steam table, appropriate sized trays, tray lids, thermometer, analytical balance or measuring cup, stove, timer, and a pot with a lid. The texture, flavor and color of the risotto food product was observed at 0 hours, 1 hours, 2 hours, 3 hours, and 4 hours. The test was preformed as follows:

1. Add water to steam table (half way). Turn on high to heat water (water temp near boiling, 195-212° F.).

2. Prepare rice according to prep instructions.

3. Transfer to a steam table tray, take initial measurement.

4. Cover tray and empty space with lid as shown here

5. If necessary, adjust heat to ensure rice temperature remains around 160° F. (190° F. for temp. abuse study)

6. Take measurements every hour and record findings for texture, flavor and color.

The results of the steam table test showed that the rice texture and appearance start falling apart after 3 hours of steam table hold for the samples that have more non-parboiled white rice. The higher non-parboiled rice (>45%) (weight basis of the total amount of dry rice) samples had much higher back extrusion stickiness and there was also a much higher percent (>25%) (weight basis on the total RTH product after steam table hold) of broken kernels observed.

It was observed from the foodservice steam table test that the above specified rice blend matched the superior product quality of the traditionally stove top prepared risotto products. The product within the specified ranges has less rice case-hardening* over three months shelf life in the package. (*Rice case-hardening is due to the retrogradation of the gelatinized rice inside the ready to heat rice package. Over the shelf life storage the force that takes to break the hardened rice in the package is increased with the storage time.) The prepared risotto on the steam table* has less degree of rice breakage over the steam table hold. And the texture of the prepared risotto was closer in firmness and the cohesiveness of the risotto stickiness comparing to the stove top traditionally cooked risotto. (*Steam table hold is how most of the rice is served over a period of time in the restaurant and institution where the cooked rice is held in a tray kept under a constant heat source that maintains the temperature of the product at or above 160° F. A typical steam table hold time is not more than 3 hours.)

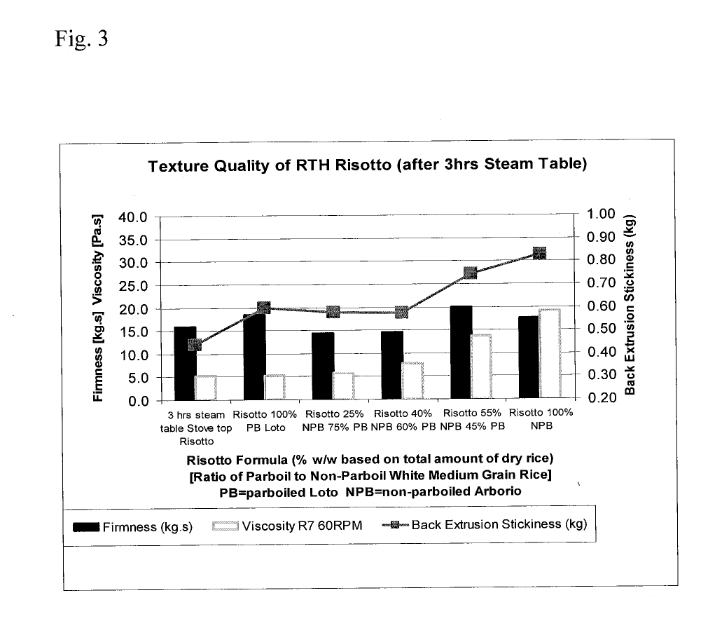

FIG. 3 is a graph that illustrates the texture quality of different risotto samples made with different ratios of parboiled and non-parboiled rice after 3 hours on a steam table. As illustrated, rice quality attributes, such as stickiness, firmness, and viscosity, have a similar trend on freshly cooked versus steam table hold samples. Due to the extended steam table hold, the starch texture breaks down and the range (firmness and viscosity, specifically) became lower. The 100% parboiled medium grain are closer in texture attributes to the Blend Samples and the Stove Top reference risotto sample. This is because with higher ratio of parboiled rice blend in risotto (<40% non-parboiled) the texture and the change of texture is closer to the stove top risotto fresh and steam table hold sample

The shelf-stable RTH risotto food product is produced by providing a blend of the parboiled and non-parboiled rice grains and filling a plurality of retortable containers such as flexible retortable pouches with the blend of the rice grains. Other types of packaging formats could include cups, trays, or 2.5 lb or 5 lb. bulk packs. The ingredients of oil and water and optionally salt and/or seasonings are added to each pouch and the pouches are sealed and sterilized to achieve commercial sterility. Any thermal processing known to one skilled in the art of food processing can be used. Such thermal food processing includes retorting, ohmic heating, UHP sterilization, microwave sterilization, hydrostatic sterilization, aseptic sterilization and filling. The pouches are thereafter packaged for delivery to the foodservice and retail consumer. The pouches can contain either single serve or multi-serve quantities. When the RTH risotto food product is ready to be consumed, the contents of the pouch are placed in a container suitable for heating and a liquid, such as chicken or vegetable stock is added. Seasoning and other ingredients can be added. The risotto is heated for about 30-180 seconds, preferably 60-120 seconds per a 2 cup serving size to achieve the desired texture. The finished risotto food product has a surface creaminess and al dente texture of traditionally prepared risotto.

In the shelf stable, read-to-eat food product, 15-45% (dry weight based on the total weight of dry rice used to prepare the product) of the rice is non-parboiled rice and 55-85% (dry weight based on the total weight of dry rice used to prepare the product) of the blend is parboiled rice. Preferably, 20-35% (dry weight based on the total weight of dry rice used to prepare the product) of the rice is non-parboiled rice and 65-80% (dry weight based on the total weight of dry rice used to prepare the product) of the blend is parboiled rice. Most preferably, 25-30% (dry weight based on the total weight of dry rice used to prepare the product) of the rice is non-parboiled rice and 70-75% (dry weight based on the total weight of dry rice used to prepare the product) of the blend is parboiled rice.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A process for the production of a shelf-stable ready-to heat risotto food product comprising the steps of:
providing a blend of parboiled and non-parboiled rice grains;
filling a plurality of retortable containers with the blend of rice grains;
adding the ingredients of oil and water and each container;
seal and sterilize each container;
wherein after heating by a consumer, the risotto food product has a texture comparable to traditionally prepared risotto.

2. The process of claim 1, further including the step of adding seasonings to each container prior to sealing and sterilizing each container.

3. The process of claim 1, wherein the blend of rice grains includes 15-45% of the non-parboiled rice and 55-85% of the parboiled rice.

4. The process of claim 3, wherein the blend of rice grains includes 20-35% of the non-parboiled rice and 65-80% of the parboiled rice.

5. The process of claim 4, wherein the blend of rice grains includes 25-30% of the non-parboiled rice and 70-75% of the parboiled rice.

6. The process of claim 1, wherein the blend of rice grains for a foodservice product includes 1-40% of the non-parboiled rice and 60-99% of the parboiled rice.

7. The process of claim 6, wherein the blend of rice grains for the foodservice product includes 5-35% of the non-parboiled rice and 65-95% of the parboiled rice.

8. The process of claim 7, wherein the blend of rice grains for the foodservice product includes 15-30% of the non-parboiled rice and 70-85% of the parboiled rice.

9. The process of claim 1, wherein the texture comprises the surface creaminess and al dente bite of traditionally prepared risotto.

10. The process of claim 1, further including the steps of adding additional liquid and heating prior to consumption by a consumer.

11. A shelf stable risotto food product comprising:
ready-to-heat risotto having a blend of parboiled and non-parboiled rice grains;
wherein the blend of parboiled and non-parboiled rice grains provide a surface creaminess and al dente texture of traditionally prepared risotto.

12. The food product of claim 11, wherein 15-45% of the blend is non-parboiled rice and 55-85% of the blend is parboiled rice.

13. The food product of claim 12, wherein the blend of rice grains includes 20-35% of the non-parboiled rice and 65-80% of the parboiled rice.

14. The food product of claim 13, wherein the blend of rice grains includes 25-30% of the non-parboiled rice and 70-75% of the parboiled rice.

15. The food product of claim 11, wherein the parboiled rice is a milled rice, the parboiled rice has a low to intermediate amylose content, and the parboiled rice is selected from the group consisting of short grain rice and medium grain rice.

16. The food product of claim 11, wherein the non-parboiled rice is a milled rice, the non-parboiled rice has a low to intermediate amylose content, and the non-parboiled rice is selected from the group consisting of short grain rice and medium grain rice.
